(19) United States
(12) Patent Application Publication
(10) Pub. No.: US 2014/0153502 A1
(43) Pub. Date: Jun. 5, 2014

(54) WIRELESS LINK METHOD AND SYSTEM USING MULTIBAND

(71) Applicant: ELECTRONICS AND TELECOMMUNICATIONS RESEARCH INSTITUTE, Daejeon (KR)

(72) Inventors: Bong Su KIM, Daejeon (KR); Min Soo KANG, Daejeon (KR); Kwang Seon KIM, Daejeon (KR); Woo Jin BYUN, Daejeon (KR)

(73) Assignee: ELECTRONICS AND TELECOMMUNICATIONS RESEARCH INSTITUTE, Daejeon (KR)

(21) Appl. No.: 13/953,312

(22) Filed: Jul. 29, 2013

(30) Foreign Application Priority Data
Dec. 3, 2012 (KR) 10-2012-0138770

(51) Int. Cl. H04L 5/06

(52) U.S. Cl. CPC H04L 5/06
USPC 370/329

(57) ABSTRACT

Provided is a wireless link system using a multiband, the system including: a common baseband module to operate in a first frequency band and a second frequency band higher than the first frequency band; at least one low radio frequency (RF) module to process a signal output from the common baseband module in the first frequency band; at least one high RF module to process a signal output from the common baseband module in the second frequency band; a plurality of antennas electrically connected to the at least one low RF module and the at least one high RF module; and a control unit to adaptively allocate a control signal and data to the at least one low RF module and the at least one high RF module based on state information of a wireless channel.

### CROSS-REFERENCE TO RELATED APPLICATION

This application claims the priority benefit of Korean Patent Application No. 10-2012-0138770, filed on Dec. 3, 2012, in the Korean Intellectual Property Office, the disclosure of which is incorporated herein by reference.

### BACKGROUND

1. Field of the Invention

The present invention relates to a wireless link system and method using a multiband, and more particularly, to a technology of using a common baseband that operates in a multiband.

2. Description of the Related Art

In a wireless communication system, a wireless link technology may refer to a technology of additionally installing and using a backup link used only when an existing link is disconnected. Accordingly, in addition to the additional backup link, a baseband module with respect to the backup link may need to be additionally installed.

### SUMMARY

Embodiments of the present invention provide a method, apparatus, and system for sharing a baseband module to output a signal in a first frequency band and a second frequency band higher than the first frequency band.

Embodiments of the present invention also provide a method, apparatus, and system for adaptively using a first frequency band and a second frequency band based on state information of a wireless channel using a common baseband module.

Embodiments of the present invention also provide a method, apparatus, and system for adaptively allocating a control signal and data while adaptively using a first frequency band and a second frequency band.

Embodiments of the present invention also provide a method, apparatus, and system for adaptively connecting an uplink and a downlink while adaptively using a first frequency band and a second frequency band.

According to an aspect of the present invention, there is provided a wireless link system using a multiband, the system including: a common baseband module to operate in a first frequency band and a second frequency band higher than the first frequency band; at least one low radio frequency (RF) module to process a signal output from the common baseband module in the first frequency band; at least one high RF module to process a signal output from the common baseband module in the second frequency band; a plurality of antennas electrically connected to the at least one low RF module and the at least one high RF module; and a control unit to adaptively allocate a control signal and data to the at least one low RF module and the at least one high RF module based on state information of a wireless channel.

When a data transmission and reception rate of the second frequency band is greater than or equal to a first parameter, the control unit may allocate the control signal to the at least one low RF module and may allocate the data to the at least one high RF module.

When the data transmission and reception rate of the second frequency band is less than or equal to a second parameter, the control unit may allocate a portion of the data and the control signal to the at least one low RF module and may allocate the data to the at least one high RF module.

When the data transmission and reception rate of the second frequency band is less than or equal to a third parameter that is less than the second parameter, the control unit may allocate the control signal and the data to the at least one low RF module without using the at least one high RF module.

State information of the wireless channel may be obtained based on information about the data and or may be received from the at least one low RF module.

According to another aspect of the present invention, there is provided a wireless link method using a multiband, the method including: outputting a signal of each of a first frequency band and a second frequency band higher than the first frequency band using a common baseband module; adaptively allocating a control signal and data to at least one low RF module electrically connected to at least one antenna, and at least one high RF module electrically connected to at least one antenna, based on state information of a wireless channel; processing the signal of the first frequency band using the at least one low RF module; and processing the signal of the second frequency band using the at least one high RF module.

According to still another aspect of the present invention, there is provided a wireless link system using a multiband, the system including: a common baseband module to operate in a first frequency band and a second frequency band higher than the first frequency band; at least one low RF module to process a signal output from the common baseband module in the first frequency band; at least one high RF module to process a signal output from the common baseband module in the second frequency band; a plurality of antennas electrically connected to the at least one low RF module and the at least one high RF module; and a control unit to adaptively connect the at least one low RF module and the at least one high RF module to an uplink and a downlink based on state information of a wireless channel.

When a data transmission and reception rate of the second frequency band is greater than or equal to a first parameter, the control unit may connect the at least one low RF module to the uplink and may connect the at least one high RF module to the downlink.

When the data transmission and reception rate of the second frequency band is less than or equal to a second parameter, the control unit adjusts a data amount of signals processed by the at least one low RF module and the at least one high RF module.

When the data transmission and reception rate of the second frequency band is less than or equal to a third parameter that is less than the second parameter, the control unit may connect the at least one low frequency RF band to the uplink and the downlink without using the at least one high RF module.

According to still another aspect of the present invention, there is provided a wireless link method using a multiband, the method including: outputting a signal of each of a first frequency band and a second frequency band higher than the first frequency band using a common baseband module; adaptively connecting, to an uplink and a downlink, at least one low RF module electrically connected to at least one antenna, and at least one high RF module electrically connected to at least one antenna; processing the signal of the first frequency band using the at least one low RF module; and processing the signal of the second frequency band using the at least one high RF module.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a wireless link system according to a related art;

FIG. 2 is a graph illustrating rainfall attenuation for each frequency band according to the related art;

FIG. 3 is a diagram illustrating a wireless link system using a wireless link system using a multiband according to an embodiment of the present invention;

FIG. 4 is a diagram illustrating a wireless link system to allocate a control signal and data to a low radio frequency (RF) module and a high RF module according to an embodiment of the present invention;

FIG. 5 is a diagram illustrating a wireless link system to connect a low RF module and a high RF module to an uplink and a downlink according to an embodiment of the present invention;

FIG. 6 is a flowchart illustrating a wireless link method for allocating a control signal and data to a low RF module and a high RF module according to an embodiment of the present invention;

FIG. 7 is a flowchart illustrating a wireless link method for connecting a low RF module and a high RF module to an uplink and a downlink according to an embodiment of the present invention; and

FIG. 8 is a block diagram illustrating a wireless link system using a multiband according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

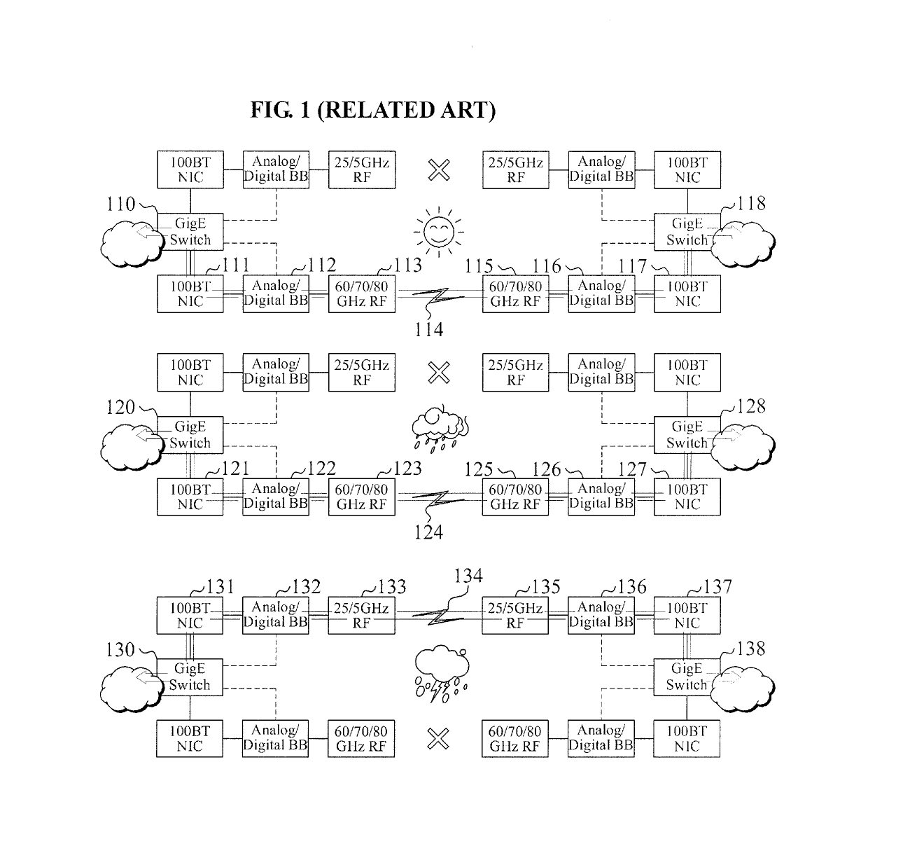

FIG. 1 is a diagram illustrating a wireless link system according to a related art.

Referring to FIG. 1, the wireless link system according to the related art includes a basic link for connecting a transmission end and a reception end using a basic path, and a backup link for connecting a transmission end and a reception end using a backup path. Here, the transmission end connected with the reception end using the basic link may include a GigE switch 110 or 120, a 1000BT network interface card (NIC) 111 or a 100BT NIC 121, an analog/digital baseband (BB) module 112 or 122, and a transmission module 113 or 123. Each of the GigE switch 110 or 120, the 1000BT NIC 111 or the 100BT NIC 121, the analog/digital BB module 112 or 122, and the transmission module 113 or 123 may be connected using the basic path. Also, the reception end connected with the transmission end using the basic link may include a reception module 115 or 125, an analog/digital BB module 116 or 126, a 1000BT NIC 117 or a 100BT NIC 127, and a GigE switch 118 or 128. Each of the reception module 115 or 125, the analog/digital BB module 116 or 126, the 1000BT NIC 117 or the 100BT NIC 127, and the GigE switch 118 or 128 may be connected using the basic path.

The transmission end connected with the reception end using the backup link may include a GigE switch 130, a 100BT NIC 131, an analog/digital BB module 132, and a transmission module 133. Each of the GigE switch 130, the 100BT NIC 131, the analog/digital BB module 132, and the transmission module 133 may be connected using the backup path. Also, the reception end connected with the transmission end using the backup link may include a reception module 135, an analog/digital BB module 136, a 100BT NIC 137, and a GigE 138. Each of the reception module 135, the analog/digital BB module 136, the 100BT NIC 137, and the GigE 138 may be connected using the backup path.

The wireless link system according to the related art may use a low frequency band as the backup link, and may use, as the basic link, a relatively high frequency band compared to a frequency band of the backup link. Each of the basic link and the backup link may have an NIC, an analog/digital BB module, and a transmission module.

When a data transmission and reception rate of a frequency band of the basic link is greater than or equal to a predetermined value, for example, when it is sunny and thus, an environment associated with the frequency band of the basic link is excellent, the basic link may be used as a wireless link. Here, Ethernet data of a gigabit class may be input through the GigE switch 110 and be converted to high speed serial data by the 1000BT NIC 111 and then be transferred to the analog/digital BB module 112. Also, a modulation and demodulation technology, such as forward error correction (FEC) and modulation, for example, may be applied to the transferred serial data to be suitable for a wireless environment. The applied serial data may be transmitted to the reception module 115 in operation 114. Here, a reception process at the reception end may be performed inversely with respect to a transmission process performed at the transmission end.

When a data transmission and reception rate of a frequency band of the basic link is less than or equal to a predetermined value, for example, when it is cloudy and thus, an environment associated with the frequency band of the basic link is not excellent, the basic link may be used as the wireless link by adjusting an input data amount. Here, Ethernet data may be input through the GigE switch 120 of the transmission end and be converted to serial data by the 100BT NIC 121. Next, the aforementioned transmission process may be performed through operation 124.

When the data transmission and reception rate of the frequency band of the basic link is less than or equal to a predetermined small value, for example, when it is stormy and thus, the environment associated with the frequency band of the basic link is poor, the backup link may be used as the wireless link. Here, the basic link may not be used. In the case of, using the backup ink as the wireless link, data may be input through a GigE switch 130 and be converted to serial data by a 100BT NIC 131 and then be transferred to an analog/digital BB module 132. Also, a modulation and demodulation technology may be applied to the transferred serial data to be suitable for a wireless environment and then be transmitted to a reception module 135 of the reception end in operation 134.

That is, the existing wireless link system may not adaptively use the basic link of the high frequency band and the backup link of the relatively low frequency band compared to the frequency band of the basic link at the same time. For example, when a link error increases due to a change in a wireless environment, the existing wireless link system may disconnect the basic link by transmitting relevant information to the GigE switch 130, and may activate the backup link of the low frequency band by converting a transmission mode of the GigE switch 130 from 1000BT to 100BT.

Here, compared to the backup link for supporting 10/100BT, the basic link for supporting 1000BT Ethernet may require a wide bandwidth of hundreds of MHz or more. To this end, a wireless link using a high frequency band in which it is easy to secure a relatively wide frequency band, for example, frequencies of 11 GHz, 18 GHz, 28 GHz, 43 GHz, 60 GHz, 70/80 GHz, and the like, may be widely used.

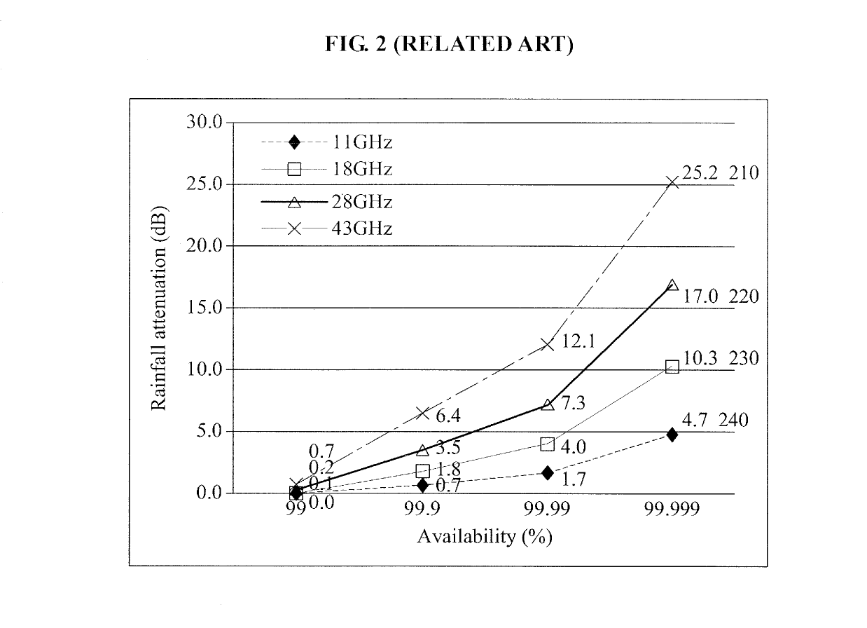

FIG. 2 is a graph illustrating rainfall attenuation for each frequency band according to the related art.

Referring to FIG. 2, the graph may include a rainfall attenuation graph 210 corresponding to a frequency band of 43 GHz, a rainfall attenuation graph 220 corresponding to a frequency band of 28 GHz, a rainfall attenuation graph 230 corresponding to a frequency band of 18 GHz, and a rainfall attenuation graph 240 corresponding to a frequency band of 11 GHz.

Compared to a wireless link of a low frequency band, a wireless link of a high frequency band may be significantly affected by a change in a wireless environment such as rainfalls. Accordingly, a basic link using a relatively high frequency band compared to a backup link may be vulnerable to the change in the wireless environment. For example, a rainfall attenuation rate of the wireless link corresponding to the frequency band of 43 GHz may be further greater than a rainfall attenuation rate of the wireless link corresponding to the frequency band of 11 GHz.

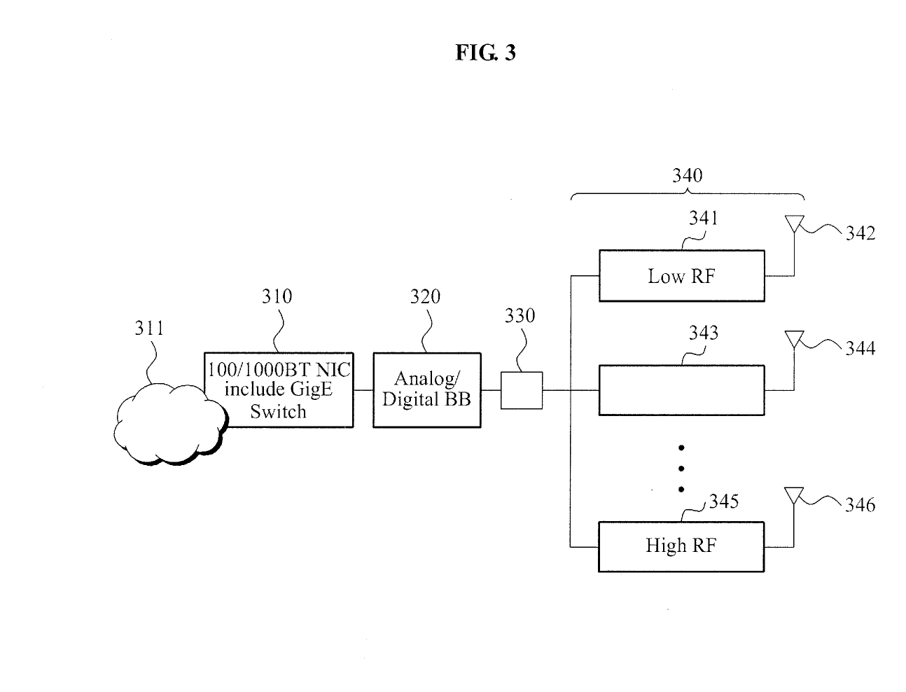

FIG. 3 is a diagram illustrating a wireless link system using a wireless link system using a multiband according to an embodiment of the present invention.

Referring to FIG. 3, the wireless link system may include a 100/1000BT NIC 310 including a GigE switch connected to the Internet 311, an analog/digital BB module 320 to operate in a first frequency band and a second frequency band higher than the first frequency band, a control unit 330, and a plurality of RF modules 340 corresponding to a plurality of frequency bands. The analog/digital BB module 320 indicates a common baseband module and thus, will be referred to as the common baseband module 320. Here, each of the 100/1000BT NIC 310 including the GigE switch, the common baseband module 320, the control unit 330, and the plurality of RF modules 340 may be connected using a path.

Although the wireless link system of FIG. 3 is described based on a transmission end, a reception end may also be configured to have the same configuration as the transmission end.

Here, the common baseband module 320 may be shared in the first frequency band and the second frequency band higher than the first frequency band, and may output a signal of each of the first frequency band and the second frequency band.

Also, the 100/1000BT NIC 310 including the GigE switch may be shared in the first frequency band and the second frequency band. Here, the 100/1000BT NIC 310 including the GigE switch may receive data by adaptively adjusting a data amount in 1000BT Ethernet and 100BT Ethernet.

The plurality of RF modules 340 corresponding to the plurality of frequency bands may include an low RF module 341 corresponding to the first frequency band, an antenna 342 electrically connected to the low RF module 341, an RF module 343 corresponding to a frequency band higher than the first frequency band, an antenna 344 electrically connected to the RF module 343, a high RF module 345 corresponding to the second frequency band higher than the first frequency band, and an antenna 346 electrically connected to the high RF module 345. Here, at least one low RF module 341 and at least one high RF module 345 may be provided. Here, an antenna may be a multi-band antenna.

The low RF module 341 may process a signal output from the common baseband module 320 in the first frequency band, and the high RF module 345 may process a signal output from the common baseband module 320 in the second frequency band.

The control unit 330 may adaptively allocate a control signal and data to the at least one low RF module 341 and the at least one RF module 345 based on state information of a wireless channel.

Also, the control unit 330 may adaptively connect the at least one low RF module 341 and the at least one RF module 345 to an uplink and a downlink based on state information of the wireless channel.

Here, state information of the wireless channel may be obtained based on information about the data or may be received from at least one low RF module 341. A further detailed description related thereto will be described later.

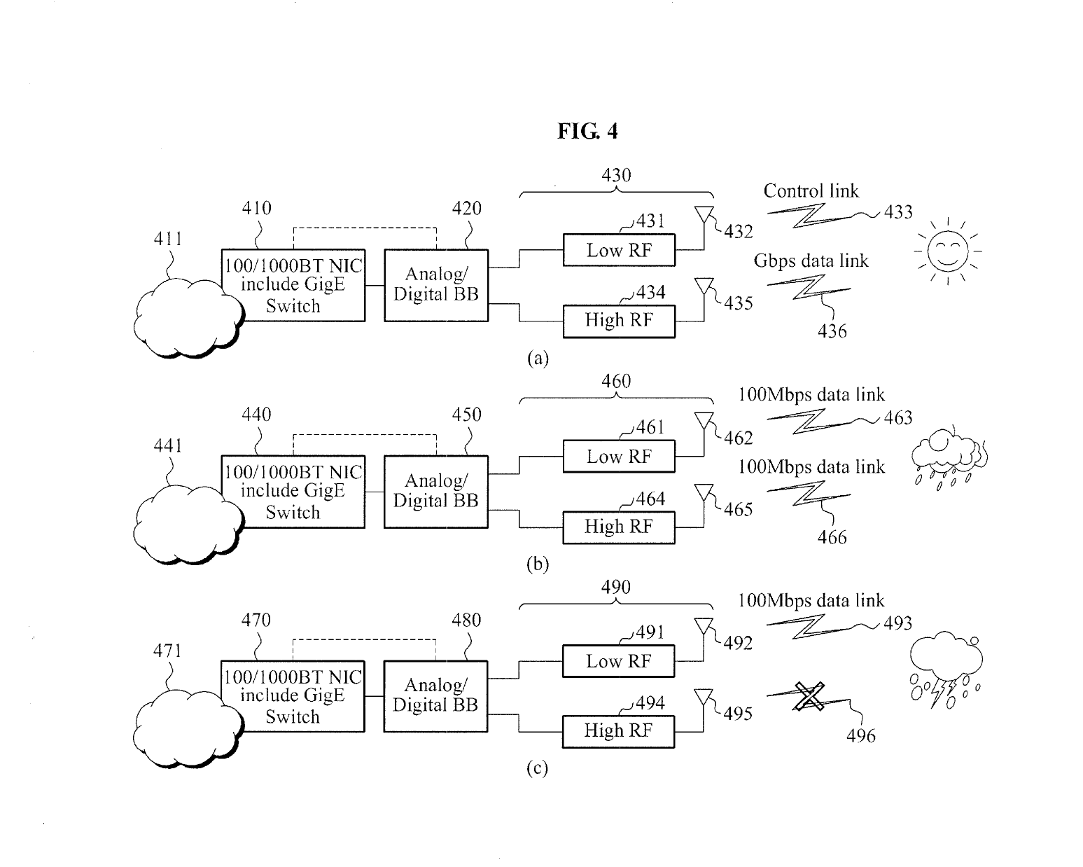

FIG. 4 is a diagram illustrating a wireless link system to allocate a control signal and data to a low RF module and a high RF module according to an embodiment of the present invention.

Referring to parts (a), (b), and (c) of FIG. 4, the wireless link system may include 100/1000BT NICs 410, 440, and 470 connected to the Internets 411, 441, and 471, respectively, and each including a GigE switch, analog/digital BB modules 420, 450, and 480 to operate in a first frequency band and a second frequency band higher than the first frequency band, and RF modules 430, 460, and 490 corresponding to a plurality of frequency bands. The analog/digital BB module 420, 450, and 480 indicate common baseband modules and thus, will be referred to as the common baseband modules 420, 450, and 480, respectively. Here, a description related to a wireless channel of a frequency band excluding the first frequency band and the second frequency band and a control unit will be omitted in order to further readily describe an example of allocating a control signal and data to a low RF module and a high RF module.

The RF modules 430, 460, and 490 corresponding to the plurality of frequency bands may respectively include RF modules 431, 461, and 491 corresponding to the first frequency band, antennas 432, 462, and 492 electrically connected to the low RF modules 431, 461, and 491, respectively, high RF modules 434, 464, and 494 corresponding to the second frequency band higher than the first frequency band, and antennas 435, 465, and 495 electrically connected to the high RF modules 434, 464, and 494, respectively.

According to an embodiment of the present invention, when a data transmission and reception rate of the second frequency band is greater than or equal to a first parameter, for example, when it is sunny and thus, an environment associated with a frequency band of a basic link is excellent, a control signal may be allocated and thereby be transmitted to the low RF module 431 in operation 433, and data may be allocated and thereby be transmitted to the high RF module 434 in operation 436.

According to an embodiment of the present invention, when a data transmission and reception rate of the second frequency band is less than or equal to a second parameter, for example, when it is cloudy and thus, a channel state of a high RF band becomes worse and transmission of a gigabit class is difficult, a portion of data and a control signal may be allocated and thereby be transmitted to the low RF module 461 in operation 463, and data may be allocated and thereby be transmitted to the high RF module 464 in operation 466. Here, the high RF module 464 may decrease a bandwidth or use a low modulation scheme. Further, the high RF module 464 may decrease a rate for stability, using a direct sequence spread spectrum (DSSS) scheme. The second parameter may have a value less than the first parameter.

According to an embodiment of the present invention, when a data transmission and reception rate of the second frequency band is less than or equal to a third parameter that is less than the second parameter, for example, when it is stormy and thus, a channel state of a high RF band is deteriorated and falls into a communication disable state, the high RF module 494 may not be used in operation 496, and a control signal and data may be allocated and thereby be transmitted to the low RF module 491. Here, the third parameter may have a value less than the second parameter.

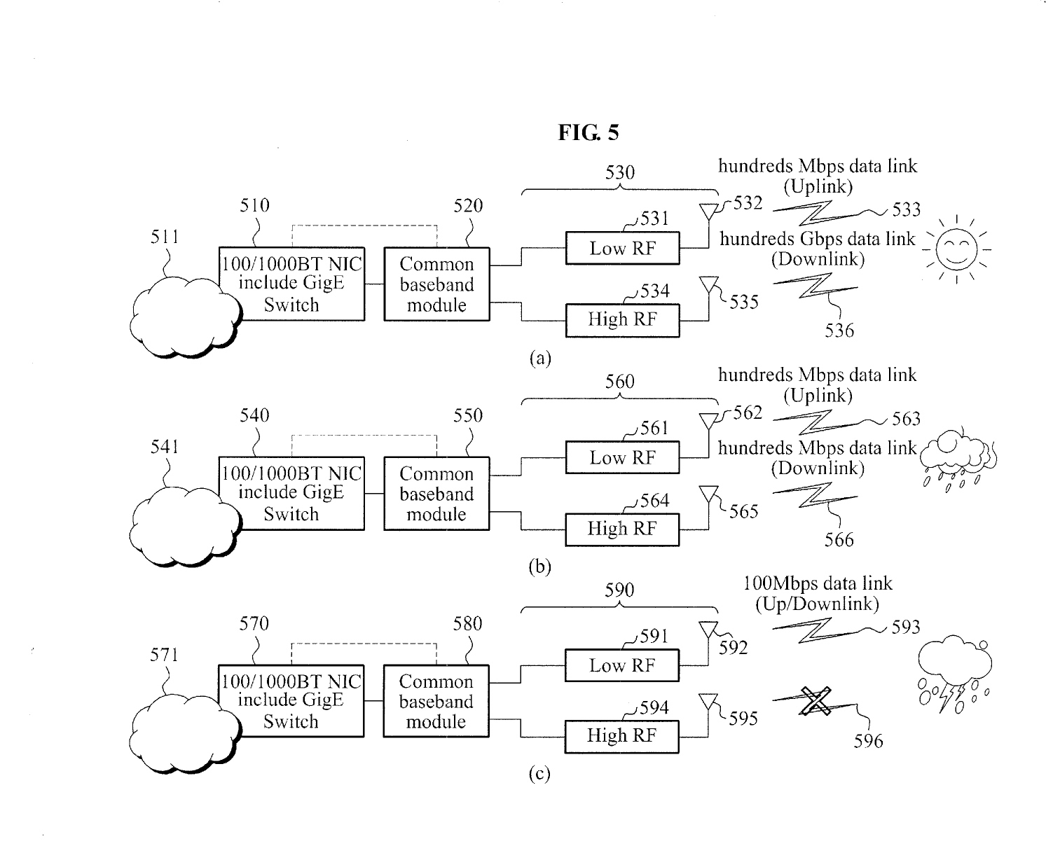

Also, according to an embodiment of the present invention, a frequency band used for upstream and downstream may be separated into the first frequency band and the second frequency band and thereby be used. A further detailed description related thereto will be made with reference to FIG. 5.

FIG. 5 is a diagram illustrating a wireless link system to connect a low RF module and a high RF module to an uplink and a downlink according to an embodiment of the present invention.

Referring to parts (a), (b), and (c) of FIG. 5, the wireless link system may include 100/1000BT NICs 510, 540, and 570 connected to the Internets 511, 541, and 571, respectively, and each including a GigE switch, analog/digital BB modules 520, 550, and 580 to operate in a first frequency band and a second frequency band higher than the first frequency band, and RF modules 530, 560, and 590 corresponding to a plurality of frequency bands. The analog/digital BB module 520, 550, and 580 indicate common baseband modules and thus, will be referred to as the common baseband modules 520, 550, and 580, respectively. Here, a description related to a wireless channel of a frequency band excluding the first frequency band and the second frequency band and a control unit will be omitted in order to further readily describe an example of connecting a low RF module and a high RF module to an uplink and a downlink.

The RF modules 530, 560, and 590 corresponding to the plurality of frequency bands may respectively include the low RF modules 531, 561, and 591 corresponding to the first frequency band, antennas 532, 562, and 592 electrically connected to the low RF modules 531, 561, and 591, respectively, high RF modules 534, 564, and 594 corresponding to the second frequency band higher than the first frequency band, and antennas 535, 565, and 595 electrically connected to the high RF modules 534, 564, and 594, respectively.

According to an embodiment of the present invention, when a data transmission and reception rate of the second frequency band is greater than or equal to a first parameter, for example, when it is sunny and thus, an environment associated with a frequency band of a basic link is excellent, the low RF module 531 may be connected to an uplink in operation 533 and the high RF module 534 may be connected to a downlink in operation 536. More specifically, for example, when it is assumed that a rate of each of the uplink and the downlink in a millimeter band is 1 Gbps and a rate of each of the uplink and the downlink in a microwave band is 100 Mbps, 20 Gbps transmission may be enabled in the downlink and 200 Mbps transmission may be enabled in the uplink.

According to an embodiment of the present invention, when a data transmission and reception rate of the second frequency band is less than a second parameter, for example, when it is cloudy and thus, a channel state of a high RF band becomes worse and transmission of a gigabit class is difficult, it is possible to adjust a data amount of signals processed by the low RF module 561 and the high RF module 564. Here, the low RF module 561 may be connected to an uplink in operation 563 and the high RF module 564 may be connected to a downlink in operation 566. The data amount of signals processed by the low RF module 561 and the high RF module 564 may be adjusted by decreasing a bandwidth, or by lowering a noise level and a signal to noise ratio (SNR) or correcting an error using a low modulation scheme, a robust FEC scheme, and the like. Also, the second parameter may have a value less than the first parameter.

According to an embodiment of the present invention, when a data transmission and reception rate of the second frequency band is less than or equal to a third parameter that is less than the second parameter, for example, when it is stormy and thus, a channel state of a high RF is deteriorated and falls into a communication disable state, the high RF module 594 may not be used in operation 596, and the low RF module 591 may be connected to an uplink and a downlink in operation 593. Here, the third parameter may have a value less than the second parameter. More specifically, for example, when the second frequency band is unavailable, it is possible to form a transmission and reception channel of 100 Mbps glass by connecting the low RF module 591 to the uplink and the downlink.

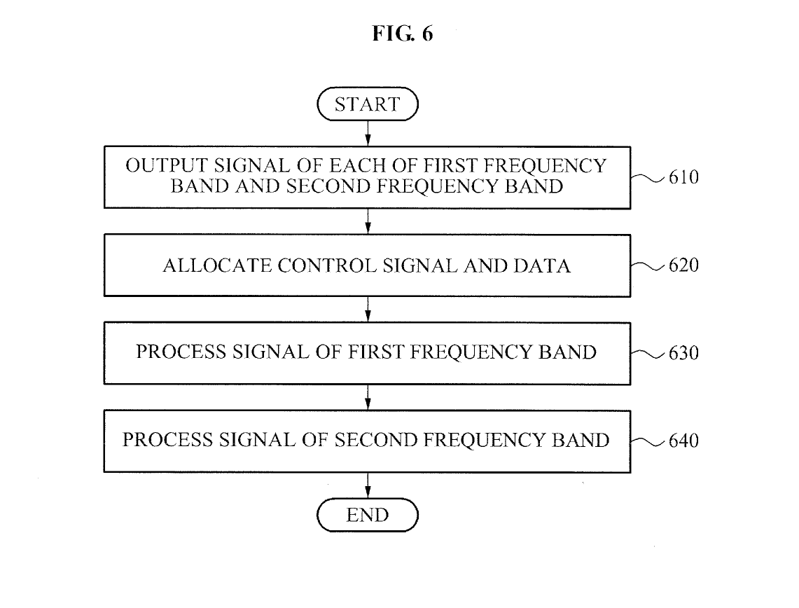

FIG. 6 is a flowchart illustrating a wireless link method for allocating a control signal and data to a low RF module and a high RF module according to an embodiment of the present invention.

Referring to FIG. 6, in operation 610, a signal of each of a first frequency band and a second frequency band higher than the first frequency band may be output using a common baseband module.

In operation 620, a control signal and data may be adaptively allocated to at least one low RF module electrically connected to at least one antenna, and at least one high RF module electrically connected to at least one antenna, based on state information of a wireless channel.

In operation 630, the signal of the first frequency band may be processed using the at least one low RF module.

In operation 640, the signal of the second frequency band may be processed using the at least one high RF module.

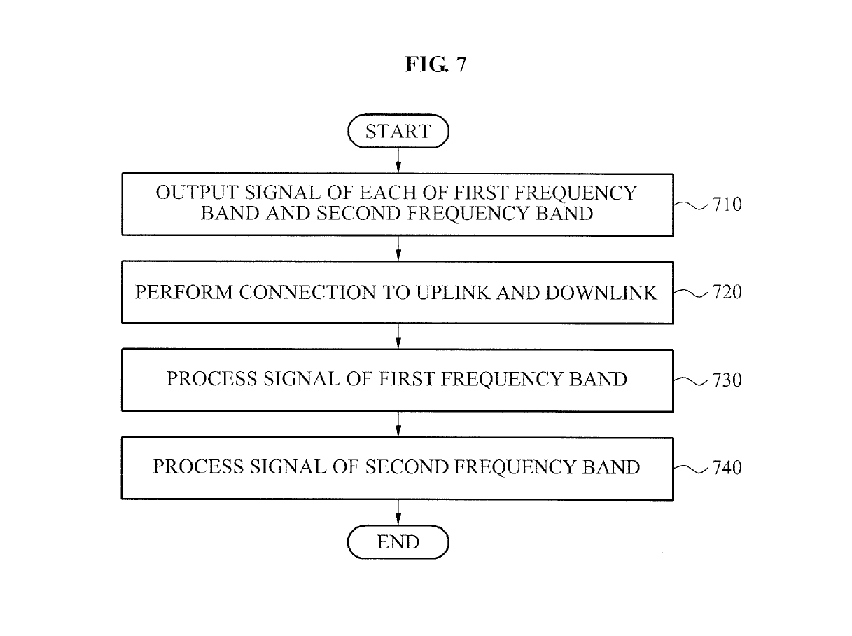

FIG. 7 is a flowchart illustrating a wireless link method for connecting a low RF module and a high RF module to an uplink and a downlink according to an embodiment of the present invention.

Referring to FIG. 7, in operation 710, a signal of each of a first frequency band and a second frequency band higher than the first frequency band may be output using a common baseband module.

In operation 720, at least one low RF module electrically connected to at least one antenna and at least one high RF module electrically connected to at least one antenna may be adaptively connected to an uplink and a downlink, based on state information of a wireless channel.

In operation 730, the signal of the first frequency band may be processed using the at least one low RF module.

In operation 740, the signal of the second frequency band may be processed using the at least one high RF module.

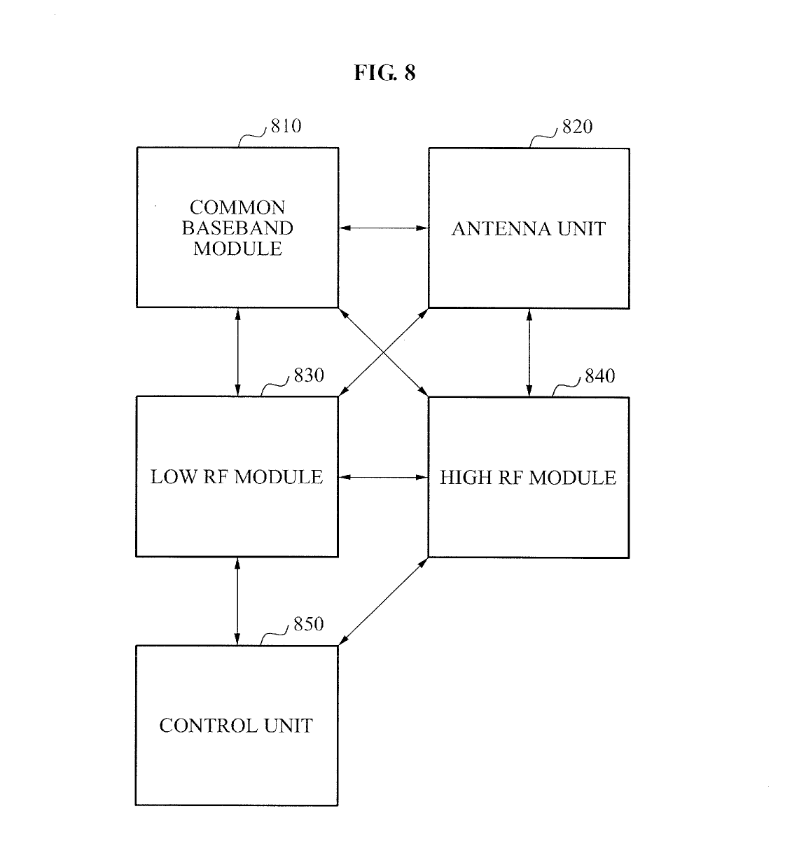

FIG. 8 is a block diagram illustrating a wireless link system using a multiband according to an embodiment of the present invention.

Referring to FIG. 8, the wireless link system may include a common baseband module 810, an antenna unit 820, a low RF module 830, a high RF module 840, and a control unit 850.

The common baseband module 810 may operate in a first frequency band and a second frequency band higher than the first frequency band.

The low RF module 830 may process a signal output from the common baseband module 810 in the first frequency band.

The high RF module 840 may process a signal output from the common baseband module 810 in the second frequency band.

The antenna unit 820 may include a plurality of antennas, and may be electrically connected to at least one low RF module 830 and at least one high RF module 840.

The control unit 850 may adaptively allocate a control signal and data to the at least one low RF module 830 and the at least one high RF module 840 based on state information of a wireless channel.

Also, the control unit 850 may adaptively connect the at least one low RF module 830 and the at least one high RF module 840 to an uplink and a downlink based on state information of the wireless channel.

According to embodiments of the present invention, there may be provided a method, apparatus, and system for sharing a baseband module to output a signal in a first frequency band and a second frequency band higher than the first frequency band.

Also, according to embodiments of the present invention, there may be provided a method, apparatus, and system for adaptively using a first frequency band and a second frequency band based on state information of a wireless channel using a common baseband module.

Also, according to embodiments of the present invention, there may be provided a method, apparatus, and system for adaptively allocating a control signal and data while adaptively using a first frequency band and a second frequency band.

Also, according to embodiments of the present invention, there may be provided a method, apparatus, and system for adaptively connecting an uplink and a downlink while adaptively using a first frequency band and a second frequency band.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory, (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wireless link system using a multiband, the system comprising:
a common baseband module to operate in a first frequency band and a second frequency band higher than the first frequency band;
at least one low radio frequency (RF) module to process a signal output from the common baseband module in the first frequency band;
at least one high RF module to process a signal output from the common baseband module in the second frequency band;
a plurality of antennas electrically connected to the at least one low RF module and the at least one high RF module; and
a control unit to adaptively allocate a control signal and data to the at least one low RF module and the at least one high RF module based on state information of a wireless channel.

2. The system of claim 1, wherein when a data transmission and reception rate of the second frequency band is greater than or equal to a first parameter, the control unit allocates the control signal to the at least one low RF module and allocates the data to the at least one high RF module.

3. The system of claim 2, wherein when the data transmission and reception rate of the second frequency band is less than or equal to a second parameter, the control unit allocates a portion of the data and the control signal to the at least one low RF module and allocates the data to the at least one high RF module.

4. The system of claim 3, wherein when the data transmission and reception rate of the second frequency band is less than or equal to a third parameter that is less than the second parameter, the control unit allocates the control signal and the data to the (*at least one low RF module without using the at least one high RF module.

5. The system of claim 1, wherein state information of the wireless channel is obtained based on information about the data or is received from the at least one low RF module.

6. A wireless link method using a multiband, the method comprising:
outputting a signal of each of a first frequency band and a second frequency band higher than the first frequency band using a common baseband module;
adaptively allocating a control signal and data to at least one low radio frequency (RF) module electrically connected to at least one antenna, and at least one high RF module electrically connected to at least one antenna, based on state information of a wireless channel;
processing the signal of the first frequency band using the at least one low RF module; and
processing the signal of the second frequency band using the at least one high RF module.

7. A wireless link system using a multiband, the system comprising:
a common baseband module to operate in a first frequency band and a second frequency band higher than the first frequency band;
at least one low radio frequency (RF) module to process a signal output from the common baseband module in the first frequency band;
at least one high RF module to process a signal output from the common baseband module in the second frequency band;
a plurality of antennas electrically connected to the at least one low RF module and the at least one high RF module; and
a control unit to adaptively connect the at least one low RF module and the at least one high RF module to an uplink and a downlink based on state information of a wireless channel.

8. The system of claim 7, wherein when a data transmission and reception rate of the second frequency band is greater than or equal to a first parameter, the control unit connects the at least one low RF module to the uplink and connects the at least one high RF module to the downlink.

9. The system of claim 8, wherein when the data transmission and reception rate of the second frequency band is less than or equal to a second parameter, the control unit adjusts a data amount of signals processed by the at least one low RF module and the at least one high RF module.

10. The system of claim 9, wherein when the data transmission and reception rate of the second frequency band is less than or equal to a third parameter that is less than the second parameter, the control unit connects the at least one low frequency RF band to the uplink and the downlink without using the at least one high RF module.

11. A wireless link method using a multiband, the method comprising:
outputting a signal of each of a first frequency band and a second frequency band higher than the first frequency band using a common baseband module;
adaptively connecting, to an uplink and a downlink, at least one low radio frequency (RF) module electrically connected to at least one antenna, and at least one high RF module electrically connected to at least one antenna;
processing the signal of the first frequency band using the at least one low RF module; and
processing the signal of the second frequency band using the at least one high RF module.
